(19) United States
(12) Patent Application Publication
(10) Pub. No.: US 2020/0406077 A1
(43) Pub. Date: Dec. 31, 2020

(54) Fire Extinguisher Truck

(71) Applicant: Mohammad Najeeb Nazhand, Sacramento, CA (US)

(72) Inventor: Mohammad Najeeb Nazhand, Sacramento, CA (US)

(21) Appl. No.: 16/451,032

(22) Filed: Jun. 25, 2019

(51) Int. Cl. A62C 31/00; A62C 27/00; A62C 19/00

(52) U.S. Cl. CPC A62C 31/00; A62C 19/00; A62C 27/00

(57) ABSTRACT

The present invention discloses a fire extinguishing device to reduce or extinguish a fire in a specific area through a truck. The truck will have air compressor unit to help fire extinguisher ball at the targeted area or remote location

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to fire safety devices, and particularly to a fire extinguishing truck used for throwing fire extinguisher balls that can be safely deployed into difficult to reach areas or to get close to the epicenter of the fire.

### Description of the Related Art

The most extensive disasters nowadays which damage our global environment and threaten life are forest fires occurring seasonally, by which more and more greenery is destroyed and life is endangered. The destruction of forests and elements of life by fires leads to ecological damage. Extensive fires also result in abandonment of mountainous areas by populations moving to plains and large cities which are connected with increases in water consumption, resulting to biological damage and to water balance alterations which may result to changes in face of the Planet. These changes of habitat have resulted in the abandonment of the vast mountainous areas which largely control the water balance and the biological action on the Earth.

One of the methods to control forest fires is the use of helicopter in hovering above the fire while dispensing a fire extinguishing substance there from. The helicopter delivers fairly sizable quantities of water to the scene of a fire from a nearby lake or other body of water. For this purpose, a large container may be suspended beneath the helicopter from its cargo hook, with the quantity of water corresponding to the load-carrying capabilities of the helicopter.

Further it is obvious that water is the best and effective natural material in these kinds of fires extinguishing. However the most quantity of the sprinkled water evaporates before causing any significant influence on the flame due to the high temperature of the flames. Usually the distance between fires and water resources are too far. Therefore water will be provided with delays in the next steps. Thus the total controlling of the flames using water as a fire extinguishing medium will be fruitless and the fire continues its expansion without any restrictions.

Hence there is a need for a fire fighting system that would eliminate the time of flight to a water source, reduce water refilling time and efficiently flight back to the fire.

A number of prior art devices are available in the art to provide temporary relief in the vicinity in which they are utilized. For example U.S. Pat. No. 3,980,139 to Kirk is one such device. The Kirk device provides a bomb that can be detonated within a fire. This device employs an ‘automatic heat triggered’ detonation means, and therefore, requires a possibly random period of time before detonation may occur. Further, due to extreme heat, the device may falsely trigger at an inappropriate time. The Kirk device also includes a glass cylinder (to hold a volume of extinguishing agent) “that can be readily fragmented so as to disperse its chemical content in all directions”. The use of this dispersal arrangement may prove to be hazardous to nearby persons when the device is detonated. A device with a safer and more directional disbursement would be useful.

None of the previous inventions and patents, taken either singly or in combination, is seen to describe the instant invention as claimed. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved way to extinguish fire through Truck. The invention is to throw fire extinguishing balls which are light and portable and could extinguish the initial fire when fired through a truck at a distant location. The truck carries fire extinguisher balls on metal channel, which is organizing and firing balls one by one. The proposed machine will throw the fire extinguisher ball on the central point of fire zone area. When thrown into the fire, it will get burst and extinguish the fire immediately.

It is another objective of the invention to provide technology which will be self-propelled fire extinguishing truck.

It is further the objective of the invention to establish in this portion of the disclosure that the present invention is environmental friendly in its basic construction, and leaves little more residue than the expended fire extinguishing/suppressant chemicals employed with the device, when actuated.

It is also the objective of the low-cost, easily manufactured, effective fire-fighting device which is, a low mass, inexpensively manufacturable containment vessel, with a maximum of fire-retardant chemical agent within such a device.

It is another objective of the invention to provide Fire Extinguisher Truck storage which can store 1750 fire extinguisher ball in one go, and each ball weights is 1.3 kg. The number of balls or the weight however is not restricted and might be increase or decrease depending on the functionality.

It is further the objective of the invention that the truck will the truck have 10 installed fire extinguisher ball throwing racks on the truck, 5 of them are on each side. The truck will have 3 roll up doors, two roll up door at the two side of the truck and one roll up door at the top of the truck. The truck will have air compressor unit to help fire extinguisher ball throwing machine for shooting the fire extinguisher ball at the targeted area or location.

The invention denotation mechanism of the truck have a GPS tracking system to send and receive data from fire zone area. In-addition the truck will have a wireless data receiver system from satellite to get update fire information and drop fire extinguisher ball at the targeted area.

To avoid shaking truck will have four hydraulic lifting jack at four corners of the truck, to deter shaking before throwing fire extinguisher ball.

A further object is to provide an assembly that is simple, rapidly adjusted and easy to use and an assembly that is economical in cost to manufacture.

A further object is to provide a conventional system of firefighting through a hose in-case of emergent need.

It is a further object of present invention is contemplated to be configured as a reusable device that may be later reloaded with a new balls and another volume extinguishing agent.

Another embodiment of the invention is that it has a fire extinguisher ball storage area and computerized truck balls filling system. The benefit of this technology is to set up extinguisher ball powder on target area uniformly and equally to turn off fire quickly and remove oxygen and the operator will use satellite to monitor the area to check need before dropping fire extinguisher ball in the area.

Still yet another object of the present invention is to provide a new and improved guided adjustable microphone stand which provides in the apparatuses and methods of the prior art some of the advantages thereof, while simultaneously overcoming some of the disadvantages normally associated therewith.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is an exemplary top and side view of the invention.

FIG. 200 shows another top view of the truck.

FIG. 300 shows top typography of the truck.

FIG. 400 shows complete top view of the invention.

FIG. 500 shows the ball throwing mechanism.

FIG. 600 shows ball dispensing mechanism.

FIG. 700 shows the interior working mechanism of the extinguishing ball throwing mechanism.

FIG. 800 shows the interior technical view of the fire extinguishing mechanism through pipe.

FIG. 900 shows typography of extinguisher ball.

FIG. 1000 shows the parking platform for the trucks.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to invent a machine to control and turn off fire by shortest time and save human life, homes and environment. The proposed invention is Fire Extinguisher Truck which throws fire extinguishing balls to remote locations. The truck can hold 1750 fire extinguisher balls in one go to be used.

As per preferred embodiment of the invention. The fire extinguishing ball, provides a safe means of extinguishing fires in typically inaccessible or hard to reach areas.

As per preferred embodiment of the invention, the truck has 4 hydraulic lifting jacks at 4 corner of the truck, to keep safe—stay strong and avid shaking before throwing fire extinguisher ball to a remote location.

Regarding the Storage area the project features:
It has fire extinguisher ball storage area and computerized truck filling magazine system,
the project have cover parking area for trucks,
there is a truck maintenance building area.

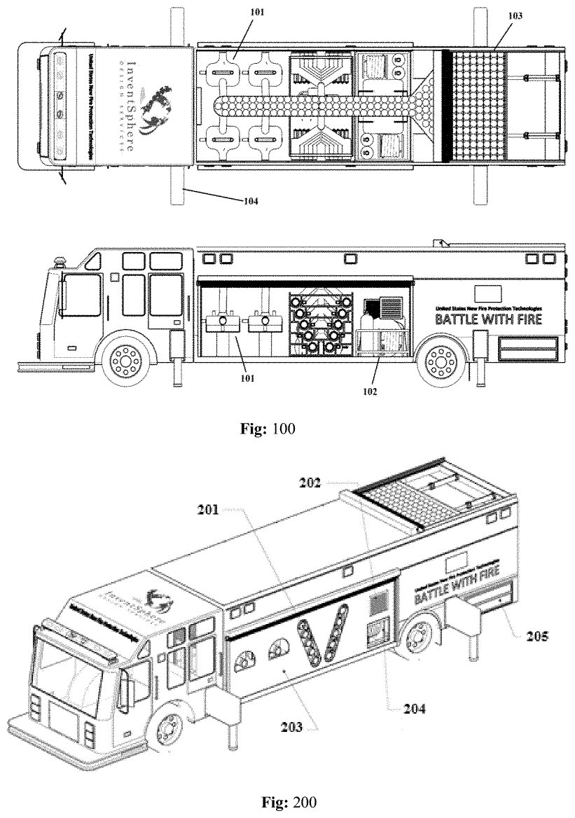

Referring now to FIG. 100, which shows complete top and side view of the truck. 101 is the fire extinguisher ball thrower device. That will get balls from the ball channel 103. There are 4 lifting jacks on each side of the truck 104 to deter shaking when in use.

FIG. 200 is another top complete view. Where ball shooting mechanism is shown 201. There is also an air flow grill 202. There is a protective metal sheet cover 203. There is also a pipe to use with hand by the firefighting people 204. The truck also consists of tool box 205.

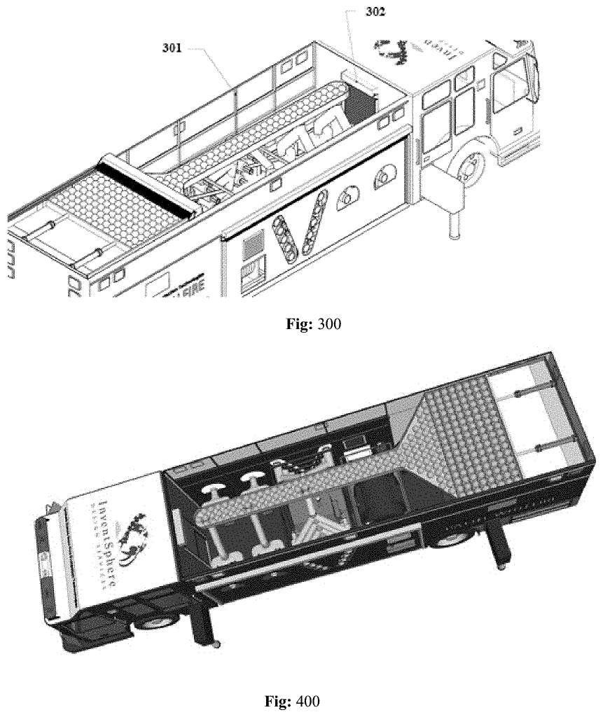

FIG. 300 shows the top typography of the truck which shows maintenance access door from within truck 302. There is also metal sheet covers on the sides 301.

FIG. 400 shows complete top view of the invention truck when in-use to extinguish fire.

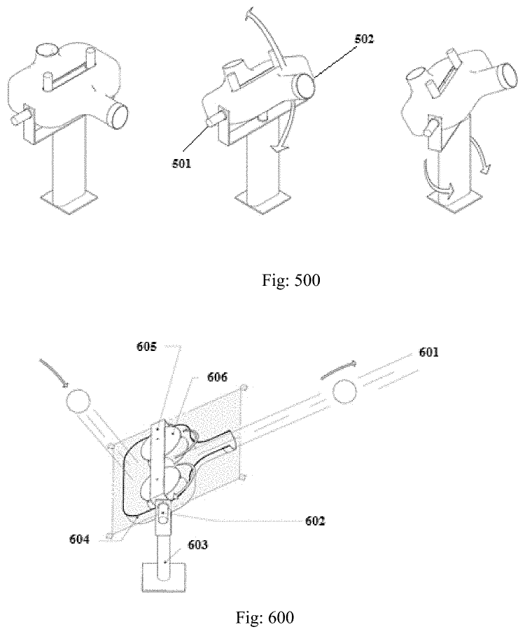

FIG. 500 shows the ball throwing mechanism. There is a handle 501 to facilitate the rotation. And the exit hole 502 for dispensing the fire extinguishing balls.

FIG. 600 shows ball dispensed 601 when in-use. 602 shows the angle adjuster. There is a stand 603 on which the device is fixed. The whole device is protected through a cover 604. There is a servo bridge 605 and rubber wheel 606.

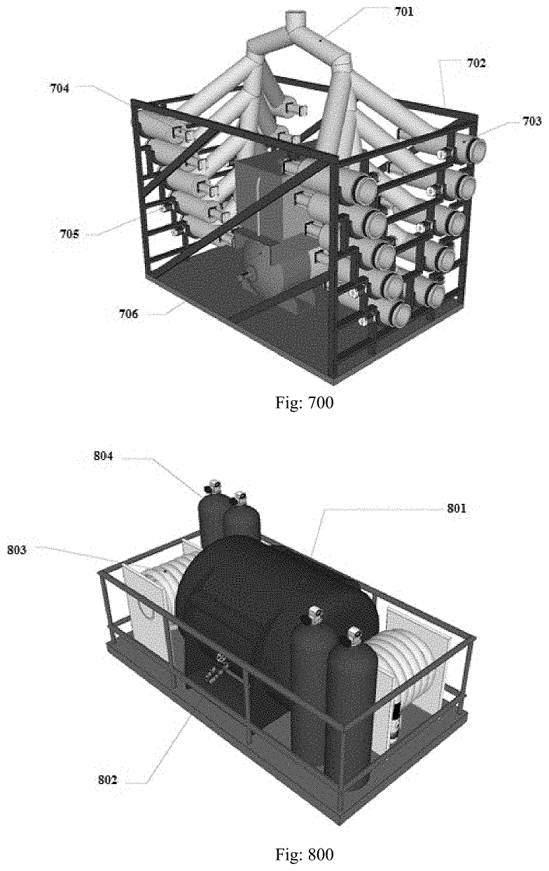

FIG. 700 shows the interior working mechanism of the extinguishing ball throwing mechanism. 701 shows flexible metal pipe that is capable to throw multiple balls one after another. 702 shows metal profile construct. 703 shows fire extinguisher ball shooting barrel. 704 shows pneumatic piston cylinder. 705 shows servo motor and 706 shows air compressor to throw the ball to a distinct location by building the pressure.

FIG. 800 shows the interior technical view of the fire extinguishing mechanism through pipe. 801 shows compressed stainless steel air tank to create pressure. 802 shows gate valve. 803 shows the fire extinguish hose. 804 shows the foam tank which stores 30 Gallon AFFF 3% Foam with high pressure gas bottle. The compressed gas drive the Foam discharge to 23 m Distance. The system is with 1″×30 m hose, and the hose reel is Automatic type. Wheels can be disassembled for Easy Transport.

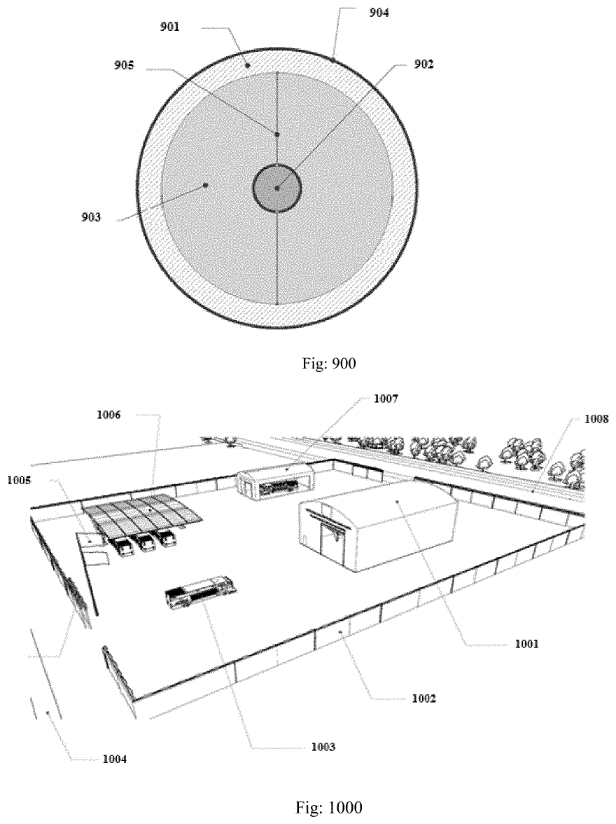

FIG. 900 shows typesetting of fire extinguishers ball. The first outer layer 904 is of film wrapping and label PEC/PVC. Then there is space 901 for Foam Non CFC. Inside the sphere there is space for extinguishing powder 903. Then there is plastic PVC for support 905 and wireless chip control charge 902.

FIG. 1000 shows the parking platform for the trucks. 1001 shows fire extinguisher ball storage building. There are also protective wall on the 4 side of the area 1002. 1003 shows fire truck in the middle. Then there is a road 1004 leading to enter through gate. 1005 show flags. 1006 shows parking sheds for trucks. 1007 shows maintenance workshop area for the trucks.

As per additional embodiment, this technology will have ball throwing mechanism to remote locations as well as hose system to tackle the fire in the accessible areas.

It is to be understood that the fire extinguishing ball encompasses a variety of alternatives. For example, the fire extinguishing ball can be constructed in a variety of sizes, depending on the needs of the user. Moreover, the body can contain specific fire extinguishing agents for specific types of fires.

An additional embodiment of the present invention is that the truck has air compressor unit for shooting the fire extinguisher ball at the targeted area or remote location.

Thus, it can be seen that the fire extinguishing ball can be an economical, solution for extinguishing fires in typically inaccessible or hard to reach places. The construction minimizes the weight of the fire extinguishing ball while providing high mobility for placing the same in the desired area.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

A fire extinguishing method through Truck comprising:

I: an air compressor unit to help fire extinguisher ball throwing machine for shooting the fire extinguisher ball at the outlying targeted areas or location.

II: The fire extinguishing device is shaped to uniformly disperse the fire extinguishing material with four hydraulic lifting jacks at four corners of the truck, to deter shaking before throwing fire extinguisher ball.

III: a conventional system of firefighting through a hose in-case of emergent need with extinguisher balls firing system.
